(19) United States
(12) Patent Application Publication
(10) Pub. No.: US 2010/0122479 A1
(43) Pub. Date: May 20, 2010

(54) SYSTEM AND METHOD FOR AERIAL ELECTROLUMINESCENT SIGN

(75) Inventor: Aaron J. Golle, Shakopee, MN (US)

Correspondence Address: SCHWEGMAN, LUNDBERG & WOESSNER, P.A., P.O. BOX 2938, MINNEAPOLIS, MN, 55402, US

(73) Assignee: Safe Lites, LLC, Eden Prairie, MN (US)

(21) Appl. No.: 12/273,000

(22) Filed: Nov. 18, 2008

(51) Int. Cl. G09F 21/14

(52) U.S. Cl. 40/215

(57) ABSTRACT

One embodiment includes an apparatus that includes a flexible tether to be coupled to an electroluminescent (EL) power source of an aircraft, the tether including an electrical conductor, a banner to be coupled to the flexible tether and an EL lamp coupled to the banner, the EL lamp in electrical communication with the electrical conductor.

### TECHNICAL FIELD

The present invention relates to method and apparatus for displaying an advertisement using a vehicle, such as towing an advertisement with the vehicle through the air, wherein portions of the advertisement are electroluminescent.

### BACKGROUND

Aerial advertising displays include signs and logos on the sides of aircraft and banners suspended from them during flight, including banners towed behind fixed-wing aircraft or suspended from slower moving aircraft such as helicopters, dirigibles and balloons. Aerial advertising displays have the advantage of being able to be seen by many people. Further options for creating attractive displays are needed.

### BRIEF DESCRIPTION OF THE DRAWINGS

FIG. 1A is a view of an example advertising system, according to some embodiments.

FIG. 1B is a cross section taken along line 1B-1B of FIG. 1A.

FIG. 2 is a view of an example advertising system, according to some embodiments.

FIG. 3 is a perspective view of a flying-start connector, according to some embodiments.

FIG. 4 is a cross sectional taken generally along line 4-4 of FIG. 1.

FIG. 5 is a cross sectional taken generally along line 5-5 of FIG. 2.

FIG. 6 is a partial view of an apparatus according to some embodiments.

FIG. 7 is a schematic according to some embodiments.

FIG. 8 is a method, according to some embodiments.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described hi sufficient detail to enable those skilled in the art to practice the invention. Other embodiments may be utilized and structural, logical, electrical changes, etc. may be made without departing from the scope of the present invention.

Aerial advertising may be provided via one or more banners that are towed by an aircraft. The banner may carry an advertisement, symbol, sign, flag or indicia, any of which is illuminated by an electroluminescent (EL) lamp. The aircraft may be any of a fixed-wing (e.g., a PIPER Cub), helicopter, airship, balloon or other flying device.

Banners are improved when they address the tendency for airplanes to fly quickly and therefore provide only a short exposure of a banner to a viewer. EL banners make messages more noticeable for the short time they are visible by a viewer. EL banners also provide illumination that makes the banner visible at night, increasing advertising time. Banners that are single-line messages in plain font are more noticeable when they include further ornament, such as illuminated portions. The addition of EL lamps to a banner adds to the effectiveness of an advertising campaign on the banner by increasing the ability of the banner to attract attention and by providing a new kind of sign that is more interesting than previous banner advertisements. EL banners and methods of their use may provide for animated banners in various embodiments.

Aerial advertising banners that include EL material provide a lighted banner system that is flexible, lightweight and affordable. Since EL material can flex many times, and since EL material is light weight, the present subject matter provides an illuminated banner that is flexible and that can withstand wind buffeting. Since EL material is less expensive than LED systems or other light systems, the present subject matter provides for affordable illuminated aerial advertising.

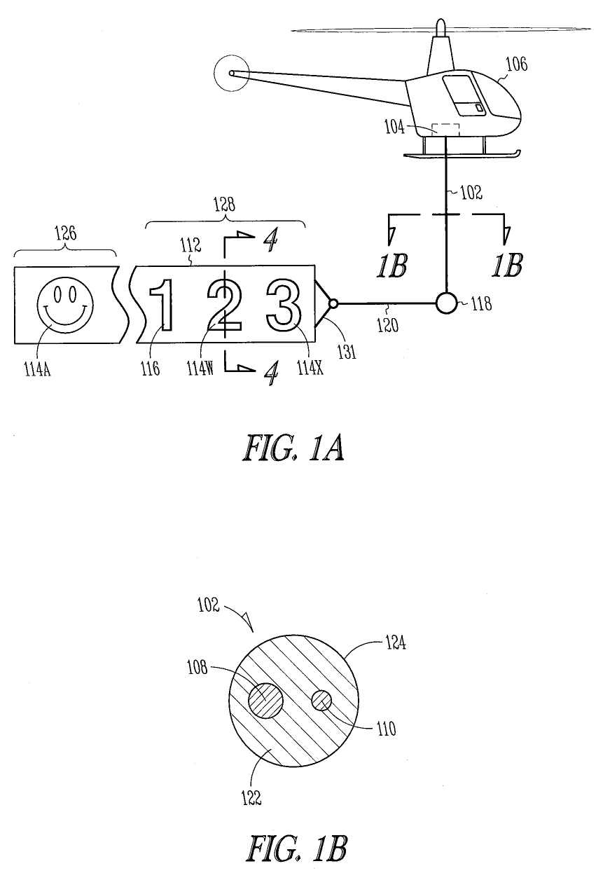

FIG. 1A is a view of an example advertising system, according to some embodiments. Various embodiments include an aircraft 106 coupled to a tether 102. The illustrated aircraft is a helicopter, but other types can be used, such as a dirigible. A banner 112 is coupled to a second tether 120, although in some embodiments it may be directly attached to the first tether 102. The second tether 120 is coupled to a weight 118 that allows the banner 116 to be coupled to the aircraft 106 during take-off and landing. The weight 118 is used to lower the flying position of the banner 112 with respect to the aircraft 106 in flight. The weight 118 functions to keep the flexible tether 102 taut. It can optionally function to maintain the banner 112 as unfurled and correctly displayed during flight, for example by providing support cables, outriggers and the like.

Interconnects between the aircraft 106 and the first tether 102, the first tether and the weight 118, the weight 118 and the second tether, and a loop 131 may be via conventional connectors such as carabiners, U-bolts or the like. Electrical connectors can be used to interconnect wiring harnesses for each of these portions.

One or more EL lamps that illuminate indicia 114A through 114X are coupled to the banner 112 and are illuminated by a power source 104 for EL via at least one electrical conductor 108. A conductor can include a wire, a braid, a cable, or another type of electricity conductor. In some embodiments, a grounded inverter is coupled to the banner, and a single electrical conductor powers the inverter to illuminate EL material.

In various embodiments, a first conductor and a second conductor are provided so that an EL load in the banner can be powered with AC power. In various embodiments, a first electrical conductor 108 and a second electrical conductor 110 extend through the first 102 and second 120 tethers. The first 108 and second 110 electrical conductors are used to satisfy the AC electricity requirements of one or more EL lamps that illuminate indicia 114A through 116X. Various embodiments include more than two conductors to enable animation of several EL lamps.

Slower-moving aircraft such as helicopters, dirigibles and balloons often are allowed greater access to airspace over cities. The aircraft are more maneuverable and often are able to be better positioned for viewing by spectators. A lower airspeed allows for larger banners and flags to be towed below and behind the aircraft. These aircraft do not use a high-speed coupling apparatus (e.g., a hook on the plane to catch a loop on the banner) to couple the aircraft 106 to the banner. In providing a banner 112 that is coupled with the aircraft 106 during take-off and landing, the present subject matter provides a platform which supports a complex electrical connection between the banner 112 and the aircraft 106. Such a complex electrical connection can include a plurality of wire pairs to light a plurality of EL lamps individually.

The banner 112 carries indicia such as advertising. An indicium or indicia can include, but are not limited to, printing, depressions, perforations, and other visual cues. The illustrated banner 112 includes indicia portions or components 126 to 128. A component is a part of a sign that is illuminated by a single EL lamp. More than two components are possible. Further, more than two banners can be towed by a single aircraft. In some embodiments, in an EL-unlit state, the components are contrasted from a depiction on the banner by colors and/or shading, and in an EL-lit state are contrasted because they are illuminated. In some of these embodiments, the depiction on the banner is not visible when the sky is darkened. A depiction could be an entire human body, while the component is the arm, in one example.

In some embodiments, all the portions of a banner are powered in parallel by the same conductor. In these embodiments, all portions illuminate simultaneously, illuminating at the same time and terminating illumination at the same time. In further embodiments, each of the portions is individually controllable to illuminate concurrently or in parallel. An example of an animation and an associated circuit is disclosed in U.S. patent application Ser. No. 11/999,494 to Golle et al., filed Dec. 4, 2007 which is commonly assigned and incorporated by reference herein in its entirety.

In various embodiments, indicia 126 to 128 are illuminated with planar EL lamps that are disposed behind a film on which the indicia are printed. According to some embodiments, indicia 126 to 128 include white portions that may be illuminated by white or light colored EL lamps. In optional embodiments, the indicia 126 to 128 are illuminated with an EL lamp producing an orange color. According to one example embodiment, the orange color or the white colors may be produced by the EL light produced directly by the lamps or by the light produced by the lamp and filtered through a colored transparent overlay, for example but not limited to as shown in U.S. Pat. No. 6,769,138 to Golle, incorporated herein by reference.

The aircraft 106 may be wrapped with advertising indicia carried on a film 120. This can be in addition to towing an EL banner. Examples of wrapping are disclosed in U.S. Provisional Patent Application No. 60/825,552, which is commonly assigned and incorporated herein by reference in its entirety.

FIG. 1B is a cross section taken along line 1B-1B of FIG. 1A. The tether 102 is a high-tension tether that may include one or more conductors. The tether can be designed to provide an insulative jacket 124 around a high tensile strength portion 122 that is designed to manage high tensile loads and to keep the first 108 and second 110 conductors from breaking. The first 108 and second 110 conductors may be coiled to provide for axial expansion.

The first tether 102 or the high tensile portion 122 may be a round line of small diameter such as standard 227 kg (500 lb) nylon parachute canopy line or round abseiling line. Ribbon-like webbing is not used for the first tether in some embodiment due to possible turbulence resulting from the airspeed of the aircraft during flight.

The second tether 120 may include 227 kg (500 lb) nylon canopy line, atlas seatbelt webbing, or another material. In some embodiments, seatbelt webbing is folded over and sewn with the leading edge of the banner between the two side edges of the webbing in order to attach the banner 102 to the lanyard 131. Folding over and sewing the webbing creates a conduit suitable for housing a wire harness.

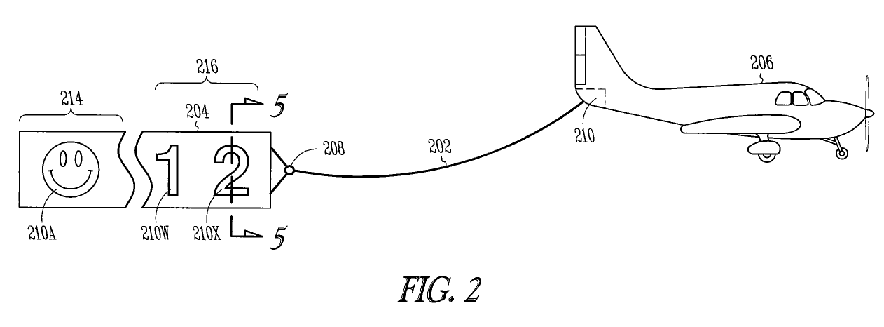

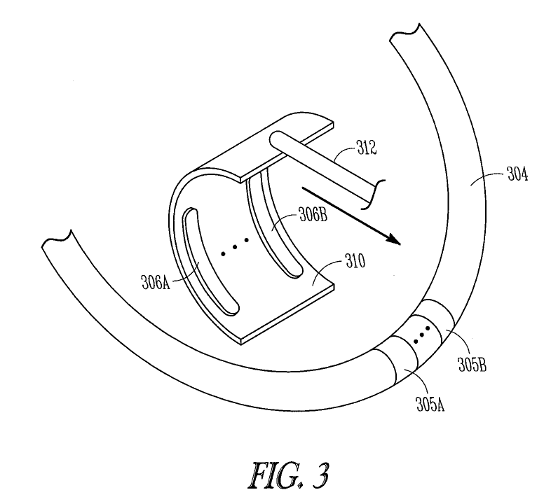

FIG. 2 is a view of an example advertising system, according to some embodiments. The aircraft 206 in this configuration is fixed-wing design. A flexible tether 202 is towed by the airplane and is to be coupled to a banner 204 via a flying-start connector 208. One example of a flying-start connector is illustrated in FIG. 3, although other configurations can be used.

In various embodiments, the airplane 206 carries an EL power source 210. This power source is coupled to the banner to light EL lamps that illuminate indicia 210A through 210X. In some embodiments, the EL lamps are distributed through portions 214 to 216. One or more circuits are used to illuminate the EL lamps. The one or more circuits are coupled to the EL power source 210, and that power source is to illuminate the EL lamps.

FIG. 3 is a perspective view of a flying-start connector, according to some embodiments. In various embodiments, a hook 302 is coupled to a tether 312 to hook a loop or catch 304 of a banner. In use, one or more electrical contacts 306A through 306B of the hook 302 contact electrical contacts or pads 308A through 308B of the tether to conduct electricity. As the airplane flies, the banner is sized to have enough drag to create adequate tension to keep the electrical contacts 306A through 306B in contact with the loop 304. Additionally, the loop is sized or preformed to maintain alignment with the contact electrical contacts 308A through 308B during flight. The contacts 306A through 306B may include gold, tin plated copper or other corrosion-resistant electrically conductive material. The pads may optionally be spring loaded.

In various embodiments, the hook has an insulative portion 310. The insulative portion can be manufactured from an electrically insulative material, or it can be constructed of a conductive material that is coated with an insulative material.

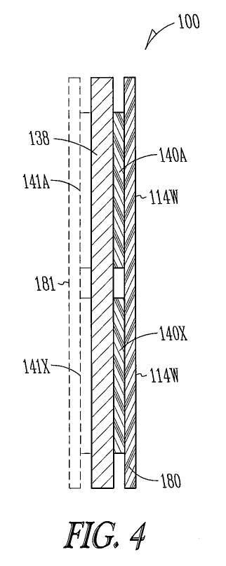

FIG. 4 is a cross sectional taken generally along line 4-4 of FIG. 1. A banner 100 includes a substrate 138 and EL lamp units 140A to 140X. The EL lamp units 140A to 140X are configured to illuminate indicia 114W on a film 180. The substrate 138 may be stiffer than the film 180. The substrate 138 may be stiffer than the EL lamp units 140A to 140X.

Although EL lamp units are shown disposed on one side of the substrate 138, further embodiments may dispose them on both sides. In embodiments in which EL lamps 141A through 141X are disposed on the other side of the substrate 138, an optional film 181 may be included on the opposite side of the substrate 138. In various embodiments, the EL lamps 141A through 141X are sealed in pockets, such as via adhesive or laminate, so that the pockets resist water seepage. Film 181 may optionally be used as a stencil in some embodiments.

In various embodiments, the EL lamp units 140A to 140X (optionally 141A through 141X) are separate EL lamps, and in additional embodiments they comprise one EL lamp. Accordingly, some embodiments allow for individual control of illumination of lamp units 140A to 140X, while others illuminate them simultaneously.

In some embodiments, the EL lamps units 140A to 140X are formed in the shape of the alphanumeric characters of indicia 114A to 114X. In these embodiments, the film 180 is translucent or absent, and viewers see indicia defined by the EL lamp units 140A through 140X.

In further embodiments, the lamp units 140A through 140X are covered with a mask or film 180 that has cut-outs that define the desired indicia. For example, in some embodiments, the film 180 has a cut out shaped like the number “2” and the film 180 exposes only the portion of the EL lamp units 140A through 140X to produce an indicium of the number “2”. Still further embodiments include a mask in which only portions are translucent or transparent. These portions may be backlit by EL. In substrate areas where there is no EL, the substrate 138 may include nonilluminated indicia. The film 180 may also include nonilluminated indicia.

Attachment of an EL lamp to a substrate may be via one or more attachment means, alone or in combination, including sewing, adhering and lamination. The EL lamp units can be attached to a film 180, such as with transparent adhesive. Film 180 can be attached to the substrate 138. For example, in some embodiments, lamp units 140A to 140X are sewn, adhered or laminated into pockets when the film 180 is coupled to the substrate. In some embodiments, the EL lamp is first coupled to a substrate, and then a film is coupled to the substrate and EL lamp assembly.

Either of the substrate 138 and the film 180 may be constructed from firm-finish 200 denier nylon, non rip polyester, Nylite 90, sail cloth, F-152 (type) nylon taffeta, cotton, rayon, polyester, twill, mixtures thereof, and the like.

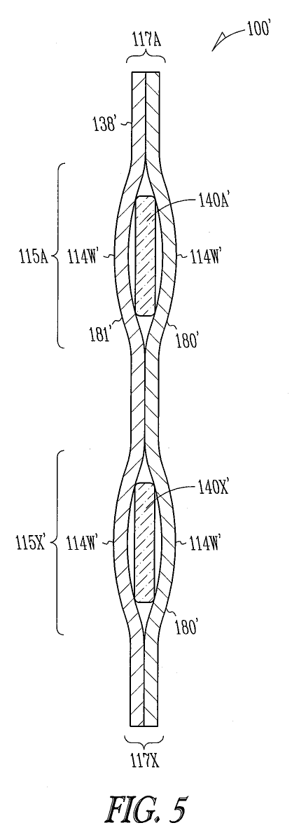

FIG. 5 is a cross sectional taken generally along line 5-5 of FIG. 2. EL lamps. The illustrated embodiments show pockets 115A′, 115X′ in which EL lamp units 140A′ through 140X′ are disposed. The pockets may be created by stitching the substrate 138′ to the film 180′. As disclosed herein, the films 180′ and 181 may be either entirely transparent, translucent, or only partially transparent or translucent. In partially translucent embodiments, an EL lamp shines through one or more translucent portions and light from the EL lamp is masked by opaque portions.

According to various embodiments, suitable materials for use as any of the films disclosed herein include thermoplastic or thermosetting polymeric materials. These may carry the advertising indicia 114A through 114X or 114A′ through 114X′. These films may be of a thickness so that they do not tear in use. The films may also be comprised of any of the materials set out above for the substrate. However, in the illustrated embodiments, the films 180′, 181′ should be at least partially translucent so that EL lamps may shine through them.

Such films may, in one example embodiment, be low surface-energy substrates. “Low surface energy” refers to materials having a surface tension of less than about 50 dynes/cm (e.g., equivalent to 50 milliNewtons/meter). The polymeric substrates are nonporous in some embodiments. Microporous, apertured, as well as materials further comprising water-absorbing particles such as silica and/or super-absorbent polymers, may also be employed provided the substrate does not deteriorate or delaminate upon exposure to water and temperature extremes, as previously described. Other suitable substrates include woven and nonwoven fabrics, particularly those comprised of synthetic fibers such as polyester, nylon, and polyolefins. The substrates as well as the imaged article (e.g. sheets, films, polymeric materials) may be clear, translucent, or opaque. Further, the substrate and imaged article may be colorless, comprise a solid color or comprise a pattern of colors. Additionally, the substrate and imaged articles (e.g. films) may be transmissive, reflective, or retroreflective.

Commercially available films include a multitude of films typically used for signage and commercial graphic uses such as available from 3M Corp. under the trade designations “Panaflex”, “Nomad”, “Scotchcal”, “Scotchlite”, “Controltac”, and “Controltac Plus”. According to one example embodiment, the aircraft 100 may be wrapped with 3M™ Controltac™ Plus Graphic Film with Comply™ Performance IJ180C-10, printed on rolls having, for example, a width of 54 in and a length of 50 yd. This 2 mil, opaque film produces high-quality, long-term graphics with selected piezo inkjet printers. The film 120 may be pressure-activated adhesive and 3M Comply™ Performance for easier installation of large fleet graphics, signs, emblems and more. In another embodiment, the film 120 may be 3M Scotchcal™ Luster Overlaminate 8519, 2 mil with PSA, 54 in×300 ft.

The imaged, polymeric films may be a finished product or an intermediate and are useful for a variety of articles including signage and commercial graphics films. The films may include a variety of advertising, promotional, and corporate identity imaged films. The films may comprise a pressure-sensitive adhesive on the non-viewing surface in order that the films can be adhered to a substrate, or optionally to another surface such as an airplane. The films in combination with any associated adhesive can range in thickness from about 5 mils (0.127 mm) to as thick as can be accommodated by a printer (e.g. ink-jet printer). According to one example embodiment, printing on the films 120 may be done using the Xaar Jet XJ128-200 piezo printhead on an x-y stage at 317 by 295 dpi at room temperature.

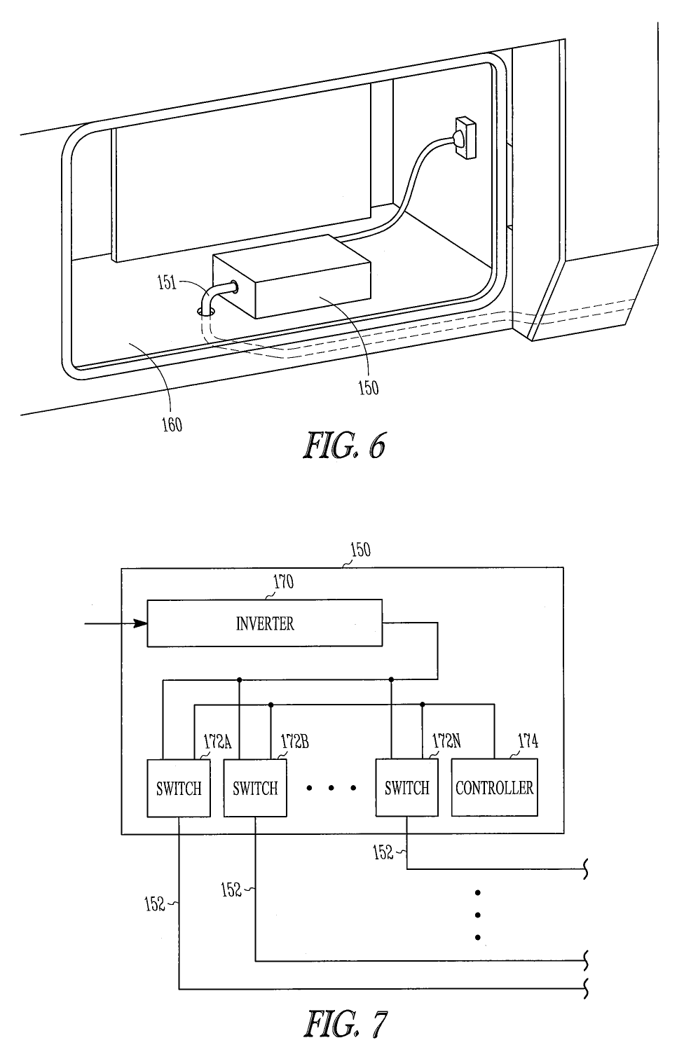

Referring now to FIGS. 6 and 7, the EL lamp units 140A to 140X are each connected to a source of energy produced by a power and control unit 150 located in an aircraft. The connection to unit 150 is provided by one or more conductors 152. In some embodiments, four are provided for each lamp unit 140A to 140X, carrying power and ground to opposite sides or ends of the lamp units. Conductors 152 may leave unit 150 wrapped as a single bundle 151, and leave the bundle 151 to run to the respective units 140A to 140X. Accordingly each of the units 140A to 140X may have its own separate power line. Alternatively, a single bus may be used to run power to each unit 140A to 140X, although such an arrangement does not allow for controlling the illumination of each unit 140A to 140X individually.

Power and control unit 150 may be housed in a wiring or electrical compartment 160 onboard an aircraft, and may be connected to a master power source, such as a 480 volt power supply or any suitable master power supply. Some embodiments include a 28 volt DC power supply that is inverted.

Cable bundle 151 runs from the unit 150 through an aperture in the floor of the compartment and to the underside of the aircraft and runs along the side edge on the bottom of the aircraft undercarriage, for example held in place with fasteners that may be attached to any suitable portion of the undercarriage.

The power and control unit 150 is shown in more detail in FIG. 7. Unit 150 may include a power inverter 170 that supplies power to conductors 152 through switches 172A through 172N. Switches 172 are in turn controlled by a computer control device or other controller device 174 that may sequentially activate switches 172A through 172N and then, for example, activate them all in combination. In another embodiment, each switch may be activated in sequence and left on until all other switches are activated, and leaving all activated for a period of time until all are deactivated. According to another example embodiment, the switches may be deployed remotely from the unit 150, such as on the undercarriage of the aircraft or adjacent the lamp unit 140, and a control line for the switch run from the control unit to the switch.

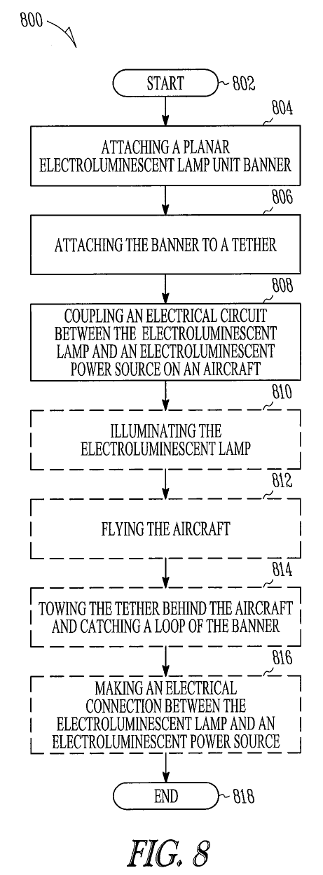

FIG. 8 is a method, according to some embodiments. The method starts at 802, and at 804, the method includes attaching a planar electroluminescent lamp unit to a banner. At 806 the method includes attaching the banner to a tether. At 808 the method includes coupling at least one conductor between the electroluminescent lamp and an electroluminescent power source on an aircraft. The method ends at 818. Various optional steps can be performed with the illustrated method. For example, at 810, various methods illuminate the electroluminescent lamp. In some examples, the lamp is illuminated intermittently according to a program.

At 812, the aircraft is flown. In some flying-start embodiments, a banner is towed behind a flying aircraft. At 814, an aircraft includes a tether that is deployed to catch a loop of a banner. Some optional embodiments include catching a loop of the banner with a hook. At 816, a method embodiment includes making an electrical connection between an electroluminescent lamp of the banner and the electroluminescent power source.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. An apparatus, comprising:
a flexible tether to be coupled to an electroluminescent (EL) power source of an aircraft, the tether including at least one electrical conductor;
a banner to be coupled to the flexible tether; and
an EL lamp coupled to the banner, the EL lamp in electrical communication with the electrical conductor.

2. The apparatus of claim 1, wherein the tether includes a flying-start connector to connect the banner to the tether and to electrically connect the EL power source to the electrical conductor.

3. The apparatus of claim 1, wherein the EL lamp is a first EL lamp and further comprising a second EL lamp coupled to the banner and in electrical communication with the electrical conductor.

4. The apparatus of claim 3, wherein the first EL lamp is coupled to a first side of the banner, and further comprising a second EL lamp coupled to a second side of the banner opposite the first side.

5. The apparatus of claim 3, wherein a second conductor electrically couples the second EL lamp to the power source.

6. The apparatus of claim 3, wherein the first EL lamp is shaped to form a component of a depiction shown on the banner.

7. The apparatus of claim 1, wherein the tether includes a high-tension portion, and at least one conductive pad coupled to the electrical conductor.

8. The apparatus of claim 7, comprising a further electrical conductor coupled to a further conductive pad.

9. The apparatus of claim 1, wherein the banner includes sail cloth.

10. A system, comprising:
an aircraft including a electroluminescent (EL) power source;
a flexible tether coupled to the aircraft including an electrical conductor coupled to the EL power source; and
a banner coupled to the flexible tether, the banner including an EL lamp in electrical communication with the EL power source via the electrical conductor.

11. The system of claim 10, wherein the electrical conductor is part of a power bus including a plurality of conductors to carry power to a plurality of EL lamps.

12. The system of claim 11, wherein the power source includes a control unit including a power inverter and a plurality of switches to selectively connect the power inverter to individual connectors on the power bus.

13. The system of claim 12, wherein the power source includes a program adapted to sequence the switches to cause the EL lamps to illuminate in sequence or combination.

14. The system of claim 10, wherein the flexible tether is coupled to the rear portion of the aircraft via a hook and loop, with the hook including a first hook contact and a second hook contact, and the loop including a first loop contact and a second loop contact, with the first hook contact being in electrical communication with the first loop contact, and the second hook contact being in electrical communication with the second loop contact.

15. The system of claim 10, wherein the aircraft is at least partially wrapped with a second EL lamp.

16. A method comprising:
attaching a planar EL lamp unit to a banner;
attaching the banner to a tether; and
coupling an electrical conductor between the electroluminescent lamp and an electroluminescent power source on an aircraft.

17. The method of claim 16, further comprising illuminating the electroluminescent lamp.

18. The method of claim 16, further comprising switching the EL lamp and a further EL lamp according to a control program.

19. The method of claim 18, further comprising towing the tether behind the aircraft and catching a loop of the banner.

20. The method of claim 19, wherein catching a loop of the banner includes making an electrical connection between the electroluminescent lamp and the electroluminescent power source.
